(19) United States
(12) Patent Application Publication
(10) Pub. No.: US 2018/0091885 A1
(43) Pub. Date: Mar. 29, 2018

(54) HEADPHONE AND MOBILE PHONE CASE

(71) Applicant: Hayes Carter, Prosper, TX (US)

(72) Inventor: Hayes Carter, Prosper, TX (US)

(21) Appl. No.: 15/719,638

(22) Filed: Sep. 29, 2017

Related U.S. Application Data
(60) Provisional application No. 62/401,210, filed on Sep. 29, 2016.

(51) Int. Cl. H04R 1/10; H02J 7/35; H04M 1/15

(52) U.S. Cl. CPC H04R 1/1025; H02J 7/355; H04R 2420/07; H04R 1/1016; H04M 1/15

(57) ABSTRACT

A system and method for storing and charging wireless headphones. The case has a headphone coupler which is used to house and secure a set of headphones within or on a case. The case further has a headphone charging device which allows the headphones to be charged while being stored.

### PRIORITY

This application claims priority to U.S. Provisional Application No. 62/401,210 filed on Sep. 29, 2016, the entirety of which is hereby incorporated by reference.

### BACKGROUND OF THE INVENTION

### Technical Field

The present invention relates to a system and method for carrying, storing, and/or charging headphones.

### Description of Related Art

Headphones are used by people in exercising, while working, commuting, etc. Typically, the headphones have comprised wired headphones which comprise a wired connection to receive both the signals for the sound as well as the power for the speakers in the headphones. However, there is a need for a wireless system which allows for the storage, holding, and/or charging of headphones.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a top view of a system in one embodiment;

FIG. 2 is a side view of a system in another embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

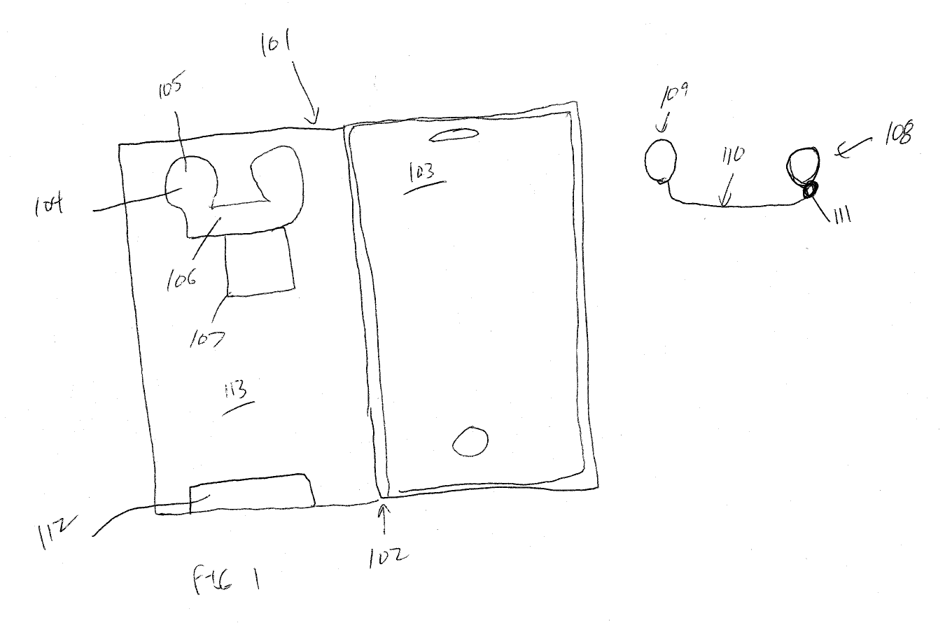

FIG. 1 is a perspective view of a system in one embodiment. As depicted the system comprises a smart device 103, a case 101, and a set of headphones 108.

The smart device 103 can comprise any smart phone, tablet, or music player known in the art. This includes traditional smart phones such as the Apple iPhone® manufactured by Apple® of Cupertino, Calif. Other phones such as the Samsung Galaxy®, or other phones made by Samsung can also be utilized. Any other smart phone can also be utilized. Other devices such as the Apple iPad®, or Apple iPod® can also be utilized and are considered smart devices 103. In one embodiment the smart device 103 is any device which can store and/or transmit sounds. In one embodiment the smart device 103 comprises a device which can send sound signals, such as music and other audio, via wireless methods. The wireless methods can include any method known in the art and includes, but is not limited to, Bluetooth and other similar standards.

The headphones 108 can comprise any headphones known in the art. The headphones can comprise both wired and wireless headphones. There are many types of headphones such as in ear, over ear, earbuds, in ear monitors, etc. In one embodiment the headphones comprise AirPods® manufactured by Apple. The headphones 108 discussed herein can comprise any of these types as well as other types of headphones. In one embodiment the headphones 108 comprise wireless headphones because they do not couple with a headphone jack to receive audio. Rather, they employ a wireless method, similar to the wireless methods discussed above herein in reference to a smart device 103. In one embodiment the smart device 103 communicates wireles sly with the headphones 108 to transmit audio to the headphones.

FIG. 1 depicts a set of headphones 108 which contains two earbuds 109 tethered via a wire 110. The wire 110, in one embodiment, electrically connects each earbud 109 to provide power and the audio signal. In one embodiment the wire 110 also serves as an antenna used to communicate with the smart device 103. In other embodiments the headphones do not comprise a wire 110 but instead the earbuds 109, for example, communicate wirelessly. On example of this is the AirPods by Apple Corporation. These headphones do not comprise a wire but instead comprise the ability to communicate wirelessly.

It should be noted that while one embodiment depicts two headphones, and earbuds specifically, this is for illustrative purposes only and should not be deemed limiting. In one embodiment, for example, a single headphone is utilized rather than a set. Further, in other embodiments hearing aids, Bluetooth earpieces and microphones can also be utilized.

As depicted, the headphones 108 also comprises a connector 111. The connector 111 allows the headphones 108 to be electrically charged or powered. Thus, the headphones 108, in one embodiment, can operate in both a wired and wireless operation. The connector 111 can accept a charge from virtually any power source. In one embodiment the connector 111 is electrically coupled to a circuit such as a power grid, a battery, etc.

The system further comprises a case 101. A case, as used herein, refers to a shell, cover, enclosure, or casing which fully or partially houses a device. In one embodiment the case at least partially covers or houses a smart device 103, such as a smart phone. A case 101 serves several purposes. First it holds and sometimes protects the smart device 103. Second a case can offer texture and grip, preventing the otherwise smart device 103 from sliding.

The system discussed herein can include virtually any case 101 known in the art. These include boxes which surround the smart device 103. In other embodiments, and as depicted in FIG. 1, the case 101 comprise a cover 113. The cover 113 folds along hinge 102 to cover the smart device 103.

The case 101 and cover 113 of FIG. 1 operate and resemble a book in that the cover 113 opens and closes to abut the smart device 103. In other embodiments, however, the case 101 will comprise more than one hinge 102. One such example is a trifold case which comprises two hinges.

While the hinge 102 is shown as being a vertical hinge, this is for illustrative purposes only and should not be deemed limiting. In other embodiments, for example, the hinge is a horizontal hinge and can be located atop or below the smart device 103.

A case 101 with a cover 113 offers several advantages. First, it offers increased surface area in which to store accessories. The accessories can include headphones, as discussed, or other accessories such as keys, credit cards, etc. Thus, the cover 101 can comprise storage for accessories. Second, it provides the security and protection features described above herein.

The case 101 can comprise virtually any material. The case 101 can comprise rubber, plastic, felt, wood, metal, other materials, and combinations thereof.

In one embodiment, and as depicted in FIG. 1, the case comprises a headphone coupler 104. As used herein, a headphone coupler 104 refers to any device which can hold and secure a pair of headphones 108.

The headphone coupler 104 can be located at any location of the case 101. It can be located on the outer side of the cover 113, or as depicted, the inner side cover 113. The inner side is the side of the cover 113 which is adjacent to the smart device 103 when the cover 113 is closed. The outer side is located on the opposite side of the inner side. One benefit of the headphone coupler 104 being located on the inner cover 113 is that the contents are secured and hidden when the cover 113 is in the closed position.

The headphone coupler 104 can comprise any device or structure which houses and holds headphones 108. As depicted the headphone coupler 104 comprises a void in the cover 113. The headphone coupler 104, in one embodiment, is sized such that the headphones 108 snugly fits within the headphone coupler 104. In one embodiment the headphones 108 are stored and maintained within the headphone coupler 104 via a friction fit between the coupler 104 and the headphones 108. In other embodiments, however, the headphone coupler 104 comprises a securement device (not depicted). The securement device can comprise a cord, lid, or cover which secures the headphones 108 within the desired location of the coupler 104. In one embodiment the securement device snaps into place to secure the headphones 108.

In one embodiment the headphone coupler 104 comprises a foam or other resilient material which can be compressed as needed to fit an object such as headphones 108. In this manner, the headphone coupler 104 is compressed when the headphones 108 are inserted. The foam seeks to expand outward, and this outward expansion offers resistance and friction keeping the headphones 108 secured in their desired location.

As depicted the headphone coupler 104 comprises a shape which mimics the headphones 108 depicted in FIG. 1. The headphone coupler 104 comprises two opposing earbud voids 105. The earbuds 109 of the headphones 108 are inserted into each void 105. The headphone coupler 104 also comprises an elongated void 106 which provides room for the wire 110 of the headphones 108.

In one embodiment, and as depicted the earbud voids 105 are separated by an elongated void 106. The earbud voids 105, as depicted, are oriented side-by-side. This means they are stored along the width of the cover 113. In other embodiments, however, the earbud voids 105 are stacked vertically. In such an embodiment the earbud voids 105 would be atop one another along the vertical length of the cover 113. In still other embodiments the earbud voids 105 are stacked along the cover's depth.

While FIG. 1 depicts earbud voids 105 separated by an elongated void 106, this is for illustrative purposes only and should not be deemed limiting. In other embodiments the two earbud voids 105 are adjacent or touching one another.

While one embodiment having a void or series of voids substantially shaped to resemble the shape of headphones, this is for illustrative purposes only and should not be deemed limiting. In another embodiment the headphone coupler 104 comprises a void but said void does not resemble the shape of headphones 108. As but one example, in one embodiment the headphone coupler 104 comprises the shape of a box, rectangle, or other shape. The headphones 108 can then be inserted into the headphone coupler 104. As noted, the coupler 104 can comprise a zipper, cover, snaps, etc. to close and/or secure the headphones 108 within their desired location within the coupler.

While one embodiment has been described wherein the headphone coupler 104 comprises a void into which the headphones 108 fit, this is for illustrative purposes only and should not be deemed limiting. In other embodiments the headphone couplers 104 comprise a hook, lock, friction fit grippers, magnets, or other devices which can couple and hold headphones 108. As but one example, in one embodiment the couplers 104 comprise a hook upon which the headphones 108 can be attached and coupled. In one such example the wire 110 of the headphones 108 can be wrapped or otherwise coupled to the hook to secure the headphones 108.

In another embodiment the headphone coupler 104 comprises at least one magnet. The magnet of the coupler 104 attaches to the headphones 108. In this manner, the headphones 108 are stored and secured in their desired location within or on the case 101 but can be removed when desired. The headphone coupler 104 can also comprise a clasp, such as buttons, etc. which secure and attach to the headphones 108.

As depicted, the case 101 further comprises a headphone charger 107. The headphone charger device 107, as used herein, refers to a charger which can electrically couple to the headphones 108 so as to allow charging or powering of the headphones 108. The headphone charger 107 can charge via any method or device known in the art including wireless charging, wired charging, etc. The headphone charger device 107 can comprise a battery, a capacitor, and other electronic components used for charging. In one embodiment the user couples or docks the headphones 108 with the headphone charger 107 such that charging can occur. The docking can be such that the headphones 108 engage and lock with the headphone charger 107. In other embodiments, however, the user plugs the headphones 108 into the headphone charger 107.

The headphone charger device 107, in one embodiment, is rechargeable. Accordingly, the headphone charger device 107 can receive a charge, charge a set of headphones 108, and then receive additional subsequent charges. The headphone charger 107 can receive a charge by any method or device known in the art. In one embodiment the headphone charger 107 can be plugged into an electrical outlet to receive power. In one embodiment the headphone charger 107 comprises a visual indicia indicating the level of power. This instructs the user whether they need to power the headphone charging device 107. In another embodiment the headphone charger 107 comprises an auditory sound to alert the user of the need to charge the headphone charging device 107.

In one embodiment the headphone charger 107 further comprises solar panels and a battery allowing the headphone charger 107 to receive electrical power without having to be plugged into an electrical outlet. In one embodiment the solar panels are incorporated into the case 101. In one such embodiment the solar panels are incorporated to the inner cover 113, the outer cover 113, or both. In still other embodiments the solar panels are not attached to the case 101, but the headphone charging device 107 can be electrically coupled to external solar panels.

In another embodiment, and as depicted, the case 101 further comprises a smart phone charger 112. The smart phone charger 112 acts similar to the headphone charger 107 but it charges the smart phone 103. The smart phone charger 112 can have all the features and abilities discussed above in reference to the headphone charger 107. In one embodiment the headphone charging device 107 and the smart device charger 112 comprise a single device. Put differently, in one embodiment a single charging device is used to charge the smart device 103 and the headphones 108. In other embodiments, and as depicted, there are two separate charging devices.

The case 101 described herein has several advantages. First, it provides a secure place for which users to store headphones 108. Anyone who has used headphones 108 knows these accessories are very easy to lose. This problem is exacerbated with wireless headphones 108 as they no longer need to be tethered via a wire to the device. As such, they are more susceptible to being lost or misplaced. The case 101 discussed herein provides a secure place to store headphones which is close and adjacent to the device in which the headphones will be used. Thus, the case discussed herein reduces the likelihood that a set of headphones will be misplaced. Instead, after using the headphones 108, the user simply couples the headphones 108 to the headphone coupler 104 for safe keeping. The headphones 108 are then available for use the next time the user desires to use the headphones 108.

Another advantage is the reduction of separate items a user needs to carry. Some headphones are packaged and stored in separate compartments. The user has to carry the headphones with them, often in a bag such as a backpack. However, the case described herein allows these separate compartments to be consolidated into a single case. Users can now carry their headphones, including wireless headphones, and their smart device in a single case.

Another advantage is the ability to charge the headphones while they are being stored. The downside for wireless headphones is that this is yet another device which must be charged. This increases the possibility that a user desires to use the headphones, only to later discover that the battery for the wireless headphones is dead. However, providing a case which simultaneously stores and optionally charges the wireless headphones allows the user to ensure their headphones are not only not lost, but charged.

The case also has the advantage of notifying the user when either the headphones, the headphone charging device, the smart device, and/or the smart device charging device is low on power. Thus, for example, when a user opens the cover they are greeted with a flashing light to indicate that the headphone charging device needs to be charged. In other embodiments when a user opens the cover they are greeted with a flashing light to indicate that the headphones need to be charged. In still other embodiments, the user is greeted with a light, or other indicate, to indicate that the headphones and the headphone charging device are fully charged. These indicators provide reminders to the user to check on the status of the power of their headphones. This reduces the likelihood that a user will desire to use their headphones and find they are out of power.

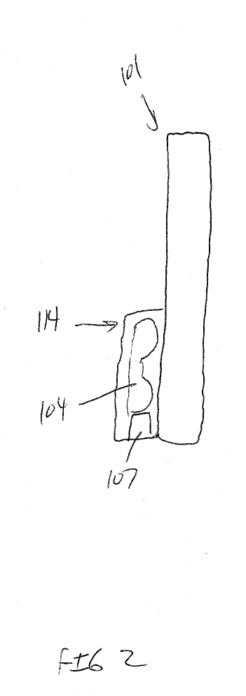

FIG. 2 is a perspective view of a system in another embodiment. In this embodiment the case 101 comprises two separate cases which are releasably coupled. As depicted the system comprises the first case 101 for housing the smart device 103. A second case, the headphone case 114 is depicted as being attached to the first case 101. The headphone case 114 can be located anywhere along the first case 101. It can be releasbly affixed via any method or device known in the art including adhesives, releasable snaps, magnets, etc. The coupler 104 can be housed within the headphone case 114 via any method discussed herein. In one embodiment the headphone case 114 has a cover which ensures the headphones 108 are fully covered. In another embodiment the headphone case 114 has an open top which becomes closed by the first case 101 when it is coupled to the first case 101.

In the embodiment depicted, the headphone charger 107 can be charged by any method discussed herein. In one embodiment, the headphone charging device 107 receives a charge from the first case 101.

The embodiment in FIG. 2 has many of the same advantages of the embodiment in FIG. 1. One additional benefit is the ability for a user to continue to use their pre-existing first case 101 for their smart device 103. The headphone case 114 can simply adhere and couple to the existing case.

While FIG. 2 shows the headphone case 114 as being a box attached to the bottom of an existing case 101, this is for illustrative purposes only and should not be deemed limiting. The headphone case 114 can be placed at any location. While in some embodiments the headphone case 114 will be shorter than the first case 101, in other embodiments it will have the same height.

In one embodiment the case 101 further comprises a traditional headphone jack. This allows traditional wired headphones to be plugged into the case 101. In one further embodiment the case 101 has wireless connectivity, such as Bluetooth connectivity. In this manner, the case 101 can connect to the smart device 103. The smart device 103 can transmit music, for example, wirelessly to the case 101, and the case 101 can transmit the music through a wired connection coupled to the case 101. This allows the case 101 to be utilized with traditional wired headphones. Many smart devices 103 are now doing away with the headphone jacks. By having a case 101 which has a traditional headphone jack and which can connect wirelessly, or wired, through a smart device 103, users can still utilize the wired headphones they already own. This is an excellent benefit in that users can still use their wired headphones even if their smart device 103 does not have a headphone jack.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.
Clause 1. A system for storing and charging wireless headphones, said system comprising:

a case;

wherein said case comprises a headphone coupler.
Clause 2. The system of any proceeding or preceding clause wherein said headphone coupler comprises a void for receiving a set of headphones.
Clause 3. The system of any proceeding or preceding clause wherein said void comprises a shape substantially similar to said set of wireless headphones.
Clause 4. The system of any proceeding or preceding clause wherein said headphones comprises a connector.
Clause 5. The system of any proceeding or preceding clause wherein said case comprises a cover which comprises an inner side and an outer side, and wherein said cover is coupled to said case via a hinge.
Clause 6. The system of any proceeding or preceding clause wherein said coupler is attached to said inner side of said cover.
Clause 7. The system of any proceeding or preceding clause wherein said headphone coupler comprises a resilient and compressible material.
Clause 8. The system of any proceeding or preceding clause wherein said case further comprises a headphone charger.
Clause 9. The system of any proceeding or preceding clause wherein said case further comprises a smart phone charger.
Clause 10. The system of any proceeding or preceding clause wherein said cover comprises solar panels.
Clause 11. The system of any proceeding or preceding clause further comprising solar panels.
Clause 12. A system for storing and charging headphones, said system comprising:

a case for at least partially housing a smart phone;

a cover coupled to said case via a hinge, wherein said cover comprises an inner side and an outer side, wherein said inner side is adjacent to said smart phone when closed;

wherein said cover comprises a headphone coupler and a headphone charger.
Clause 13. The system of any proceeding or preceding clause wherein said case further comprises a smart phone charger.
Clause 14. The system of any proceeding or preceding clause wherein said headphone coupler comprises a void for receiving a set of headphones.
Clause 15. The system of any proceeding or preceding clause wherein said void comprises a shape substantially similar to said set of headphones.
Clause 16. A system for storing and charging wireless headphones, said system comprising:

a headphone case comprising a headphone coupler and a headphone charger;

a headphone case coupler attached to said case.
Clause 17. The system of any proceeding or preceding clause further comprising a smart phone case, and wherein said headphone case coupler is releasably coupled to said smart phone case.

What is claimed is:

1. A system for storing and charging wireless headphones, said system comprising:
a case;
wherein said case comprises a headphone coupler.

2. The system of claim 1 wherein said headphone coupler comprises a void for receiving a set of headphones.

3. The system of claim 2 wherein said void comprises a shape substantially similar to said set of wireless headphones.

4. The system of claim 3 wherein said headphones comprises a connector.

5. The system of claim 1 wherein said case comprises a cover which comprises an inner side and an outer side, and wherein said cover is coupled to said case via a hinge.

6. The system of claim 1 wherein said coupler is attached to said inner side of said cover.

7. The system of claim 1 wherein said headphone coupler comprises a resilient and compressible material.

8. The system of claim 1 wherein said case further comprises a headphone charger.

9. The system of claim 1 wherein said case further comprises a smart phone charger.

10. The system of claim 1 wherein said cover comprises solar panels.

11. The system of claim 1 further comprising solar panels.

12. A system for storing and charging headphones, said system comprising:
a case for at least partially housing a smart phone;
a cover coupled to said case via a hinge, wherein said cover comprises an inner side and an outer side, wherein said inner side is adjacent to said smart phone when closed;
wherein said cover comprises a headphone coupler and a headphone charger.

13. The system of claim 12 wherein said case further comprises a smart phone charger.

14. The system of claim 12 wherein said headphone coupler comprises a void for receiving a set of headphones.

15. The system of claim 14 wherein said void comprises a shape substantially similar to said set of headphones.

16. A system for storing and charging wireless headphones, said system comprising:
a headphone case comprising a headphone coupler and a headphone charger;
a headphone case coupler attached to said case.

17. The system of claim 16 further comprising a smart phone case, and wherein said headphone case coupler is releasably coupled to said smart phone case.
